(19) United States
(12) Patent Application Publication
(10) Pub. No.: US 2015/0171976 A1
(43) Pub. Date: Jun. 18, 2015

(54) WIDEBAND RF RECEIVER

(71) Applicant: Electronics and Telecommunications Research Institute, Daejeon (KR)

(72) Inventors: Sang Tae KIM, Daejeon (KR); Haeng Sook RO, Daejeon (KR); Gwangmoon PARK, Daejeon (KR); Seong Yun LEE, Daejeon (KR); Mi-Kyung SUK, Daejeon (KR); Yong-Seok CHOI, Daejeon (KR)

(73) Assignee: Electronics and Telecommunications Research Institute, Daejeon (KR)

(21) Appl. No.: 14/217,714

(22) Filed: Mar. 18, 2014

(30) Foreign Application Priority Data
Dec. 17, 2013 (KR) 10-2013-0157391

(51) Int. Cl. H04B 17/00; H04B 1/16

(52) U.S. Cl. CPC H04B 17/0057; H04B 1/16

(57) ABSTRACT

A wideband RF receiver includes a dual mode antenna configured to drive in an active antenna mode when a bias power is supplied thereto and to drive in a passive antenna mode when a power is not supplied thereto; and a hybrid interface apparatus configured to supply the bias power to the dual mode antenna and configured to provide a control signal that enables the dual mode antenna to drive in the active antenna mode or the passive antenna mode. Further, the wideband RF receiver includes a radio measuring and receiving apparatus configured to measure a signal level of an input value that the hybrid interface apparatus outputs the control signal.

### CROSS-REFERENCE TO RELATED APPLICATION(S)

The present invention claims priority of Korean Patent Application No. 10-2013-0157391, filed on Dec. 17, 2013, which is incorporated herein by reference.

### FIELD OF THE INVENTION

The present invention relates to a wideband RF receiver, and more particular, to a wideband RF receiver having an antenna that can be driven variably by switching between passive and active antenna modes.

### BACKGROUND OF THE INVENTION

In recent years, in order to efficiently measure wideband frequency signals, a wideband RF receiver is provided with a system configuration encompassing both high frequency band and low frequency band, and studies have been made to receive both the high frequency band and low frequency band at the same time.

A RF receiver provided with an active antenna is composed of a component to amplify a received signal and a component to match an impedance of a passive antenna which varies with a frequency band of the received signal. In this connection, a prior art of Korean Patent Laid-Open Publication No. 2013-0014246, which is laid-opened published on Feb. 7, 2013, discloses an active antenna impedance matching circuit which ensures to receive at least one frequency band signal through a passive antenna.

However, a noise is added due to a signal loss when the RF signal is down converted to a lower IF signal and then is converted to a baseband signal by performing an analog signal processing or digital signal processing, which results in a reduced sensitivity of the RF receiver based on noise figure. Further, since an internal noise of the RF receiver itself and spurious cannot be distinguished from an external signal induced in the antenna, the prior art suffers from a measurement error in signal components analogous to the internal noise.

### SUMMARY OF THE INVENTION

In view of the above, the present invention provides a wideband RF receiver that is capable of increasing signal sensitivity while removing a measurement error by minimizing the loss of an RF signal received from an antenna through the supply of a bias power on one RF cable and by providing a means for separately measuring an internal noise and spurious to differentiate the internal noise from a signal component analogous to the internal noise. However, the technical subject of the present invention is not limited to the foregoing technical subject, and there may be other technical subjects.

In accordance with an embodiment of the present invention, there is provided a wideband RF receiver including: a dual mode antenna configured to drive in an active antenna mode when a power is supplied thereto and to drive in a passive antenna mode when a power is not supplied thereto; a hybrid interface apparatus configured to supply a bias power to the dual mode antenna and configured to provide a control signal that enables the dual mode antenna to drive in the active antenna mode or the passive antenna mode; and a radio measuring and receiving apparatus configured to measure a signal level of an input value that the hybrid interface apparatus outputs the control signal.

Further, the dual antenna mode may comprise an antenna path switch; a low noise amplifier disposed on an active antenna path of the antenna path switch; and a bias-tee circuit configured to separate the RF signal and the bias power such that the RF signal and the bias power are supplied to the low noise amplifier and the antenna path switch.

Further, the hybrid interface apparatus may comprise: a comb signal generating module configured to generate a reference signal of a specified frequency in a target frequency band to be measured by the wideband RF receiver; a signal level detecting module configured to measure the signal level of the RF signal inputted via the dual mode antenna; a bias power controlling unit configured to control the hybrid interface apparatus such that the power is supplied to the dual mode antenna in a case where the signal level is lower than a preset signal level and the power is not supplied to the dual mode antenna in a case where the signal level is higher than a preset signal level; and a wideband bias power controlling module configured to supply the power to the dual mode antenna in accordance with the control of the bias power controlling unit.

Further, the hybrid interface apparatus may further comprise: a receiving path selecting module configured to block a signal from the exterior in order to measure an internal spurious of the radio receiving apparatus; and an input termination circuit connected to the radio measuring and receiving apparatus by means of the receiving path selecting module, and the receiving path selecting module selects a path through which the radio measuring and receiving apparatus may be connected with the dual mode antenna.

Further, the receiving path selecting module may comprise at least one switch.

Further, the dual mode antenna and the hybrid interface apparatus may be connected by an RF cable, and the hybrid interface apparatus and the radio measuring and receiving apparatus may be connected by an RF cable.

In accordance with any one of solutions to the aforementioned subject of the present invention, it is possible to minimize the loss of the signal received from the antenna, increase the signal sensitivity and remove the measurement error.

### BRIEF DESCRIPTION OF THE DRAWINGS

The above and other objects and features of the present invention will become apparent from the following description of the embodiments given in conjunction with the accompanying drawings, in which:

FIG. 1 illustrates a block diagram of a wideband RF receiver in accordance with an embodiment of the present invention;

FIG. 2 shows a configuration diagram of the dual mode antenna shown in FIG. 1;

FIG. 3 is a block diagram of the hybrid interface apparatus shown in FIG. 1;

FIG. 4 is a block diagram explaining the comb signal generating module shown in FIG. 3;

FIG. 5 depicts a circuit diagram of the comb signal generating module, the receiving path selection module, and the input termination circuit shown in FIG. 3;

FIG. 6 is a conceptual circuit diagram explaining an internal noise of the radio measuring receiver shown in FIG. 1; and

FIG. 7 depicts a graph showing a frequency spectrum generated from the comb signal generating module shown in FIG. 3.

### DETAILED DESCRIPTION OF THE EMBODIMENTS

Hereinafter, embodiments of the present invention will be described in detail with reference to the accompanying drawings so that they can be readily implemented by those skilled in the art. However, the present invention may be embodied in different forms, but it is not limited thereto. In the drawings, further, portions unrelated to the description of the present invention will be omitted for clarity of the description, and like reference numerals and like components refer to like elements throughout the detailed description.

In the entire specification, when a portion is “connected” to another portion, it means that the portions are not only “connected directly” with each other but they are electrically connected” with each other by way of another device between them. Further, when a portion “comprises” a component, it means that the portion does not exclude another component but further comprises other component unless otherwise described. Furthermore, it should be understood that one or more other features or numerals, steps, operations, components, parts or their combinations can be or are not excluded beforehand.

Hereinafter, the embodiments of the present invention will be described in detail with reference to the accompanying drawings.

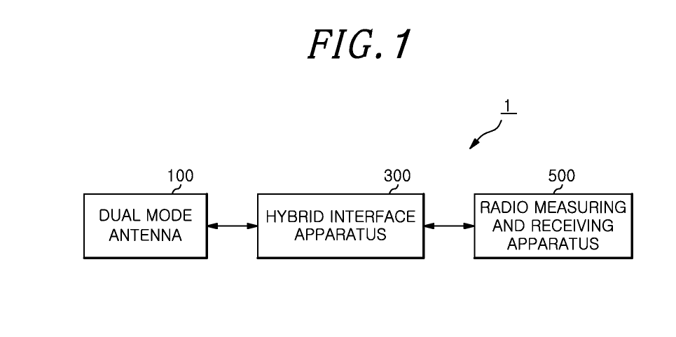

FIG. 1 illustrates a block diagram of a wideband RF receiver in accordance with an embodiment of the present invention. Referring to FIG. 1, an RF receiver 1 of the embodiment includes a dual mode antenna 100, a hybrid interface apparatus 300, and a radio measuring and receiving apparatus 500.

The dual mode antenna 100 may be driven in an active antenna mode or a passive antenna mode in compliance with a bias power provided from the hybrid interface apparatus 300. The dual mode antenna 100 may include an amplifying circuit. Specifically, the dual mode antenna 100 may be driven in the active antenna mode when the bias power is supplied from the hybrid interface apparatus 300 and may be driven in the passive antenna mode when the bias power is not supplied from the hybrid interface apparatus 300. In operation, the dual mode antenna 100 may transfer an RF signal to the hybrid interface apparatus 300, and the hybrid interface apparatus 300 may transfer the bias power to the dual mode antenna 100.

The hybrid interface apparatus 300 may measure an internal spurious or noise of the radio measuring and receiving apparatus 500. During the measurement, the hybrid interface apparatus 300 may block signals supplied from the exterior. Also, the hybrid interface apparatus 300 may supply the bias power to the dual mode antenna 100 in order for the dual mode antenna 100 to selectively drive in the active antenna mode or the passive antenna mode. In accordance with an embodiment of the present invention, one RF cable is employed to exchange the RF signal and the bias power between the hybrid interface apparatus 300 and the dual mode antenna 100. That is, the hybrid interface apparatus 300 may receive the RF signal from the dual mode antenna 100 and supply the bias power to the dual mode antenna 100 by the help of the RF cable disposed between the hybrid interface apparatus 300 and the dual mode antenna 100. In this case, the RF cable may made by combining one power line and one signal line which are separated each other.

The radio measuring and receiving apparatus 500 may measure a signal level of an input value that the hybrid interface apparatus 300 outputs a control signal. Specifically, the radio measuring and receiving apparatus 500 may measure a reference signal outputted from the hybrid interface apparatus 300 and collect a correction value to the operation state of the radio measuring and receiving apparatus 500 and the frequency measured in the radio measuring and receiving apparatus 500. Further, the radio measuring and receiving apparatus 500 may measure the internal spurious and noise level of itself when the signal supplied from the exterior is blocked by the hybrid interface apparatus 300 and store the measured ones. In response thereto, the hybrid interface apparatus 300 may generate the reference signal depending on the internal spurious and noise level stored in the radio measuring and receiving apparatus 500 and measure the signal level of the dual mode antenna 100.

In addition, the dual mode antenna 100 and the hybrid interface apparatus 300 may be connected each other by way of an RF cable disposed between them, and the hybrid interface apparatus 300 and the radio measuring and receiving apparatus 500 may be connected with each other by way of an RF cable between them.

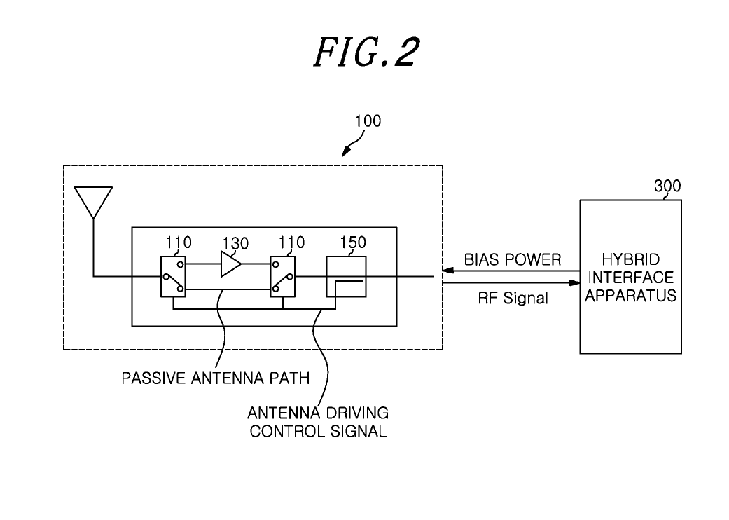

FIG. 2 shows a configuration diagram of a dual mode antenna shown in FIG. 1. Referring to FIG. 2, the dual mode antenna 100 may include an antenna path switch 110, a low noise amplifier 130, and a bias-tee circuit 150.

The dual mode antenna 100 may operate between the active antenna mode and the passive antenna mode.

The antenna path switches 110 may be implemented as a double throw switch which is connected between an antenna and the bias-tee circuit 150. The antenna path switch 110 may be switched over to drive the dual mode antenna in the active antenna mode when the power is supplied from the hybrid interface apparatus 300, whereas it may be switched over to drive the dual mode antenna in the passive antenna mode when the power is not supplied from the hybrid interface apparatus 300. To put it another way, the dual mode antenna 100 may be driven in the passive antenna mode by default without a separate control signal unless it is supplied with the power from the hybrid interface apparatus 300.

The low noise amplifier 130 may be disposed on an active antenna path of the antenna path switch 110.

During the amplifying capability of the low noise amplifier 130 is saturated, the hybrid interface apparatus 300 may not supply the bias power to the dual mode antenna. Accordingly, it is possible to prevent the signal distortion due to the saturation of the low noise amplifier 130.

The bias-tee circuit 150 may separate the RF signal and the bias power to ensure that the RF signal and the bias power are provided to the low noise amplifier 130 and the antenna path switch 110, respectively. That is, the bias-tee circuit 150 may be arranged to separate the RF signal and the bias power.

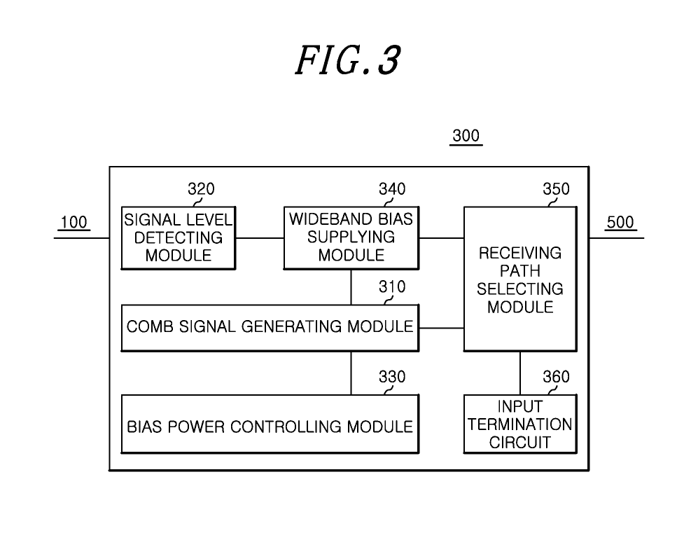

FIG. 3 is a block diagram of the hybrid interface apparatus shown in FIG. 1 in detail. Referring to FIG. 3, the hybrid interface apparatus 300 may include a comb signal generating module 310, a signal level detecting module 320, a bias power controlling unit 330, a wideband bias supplying module 340, a receiving path selecting module 350, and an input termination circuit 360.

As described above, the hybrid interface apparatus 300 may receive the RF signal from the dual mode antenna 100, supply the bias power to the dual mode antenna 100, and output the control signal that controls the dual mode antenna 100 to adaptively drive in the active antenna mode or the passive antenna mode.

The comb signal generating module 310 may generate the reference signal of a specified frequency in a target frequency band to be measured by the RF receiver 1.

The signal level detecting module 320 may measure the signal level of the dual mode antenna 100.

The bias power controlling unit 330 may control the hybrid interface apparatus 300 such that the power is supplied to the dual mode antenna 100 in a case where the signal level is lower than a preset signal level and the power is not supplied to the dual mode antenna 100 in a case where the signal level is higher than the preset signal level.

The wideband bias supplying module 340 may supply or may not supply the power to the dual mode antenna 100 in accordance with the control of the bias power controlling module 330.

The receiving path selecting module 350 may block the signal from the exterior in order to measure the internal spurious of the radio measuring and receiving apparatus 500. When the signal level is detected by the signal level detecting module 320, the receiving path selecting module 350 may select the path through which the radio measuring and receiving apparatus 500 is connected with the dual mode antenna 100. In this embodiment, the receiving path selecting module 350 may be implemented by at least one switch.

The input termination circuit 360 may be connected to the radio measuring and receiving apparatus 500 by means of the receiving path selecting module 350.

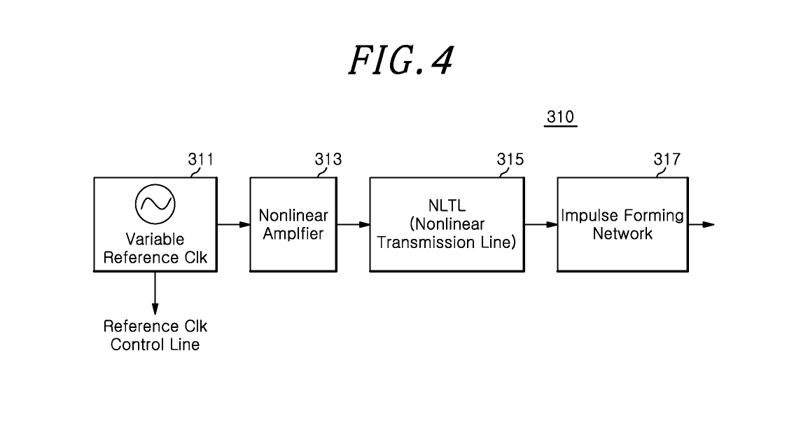

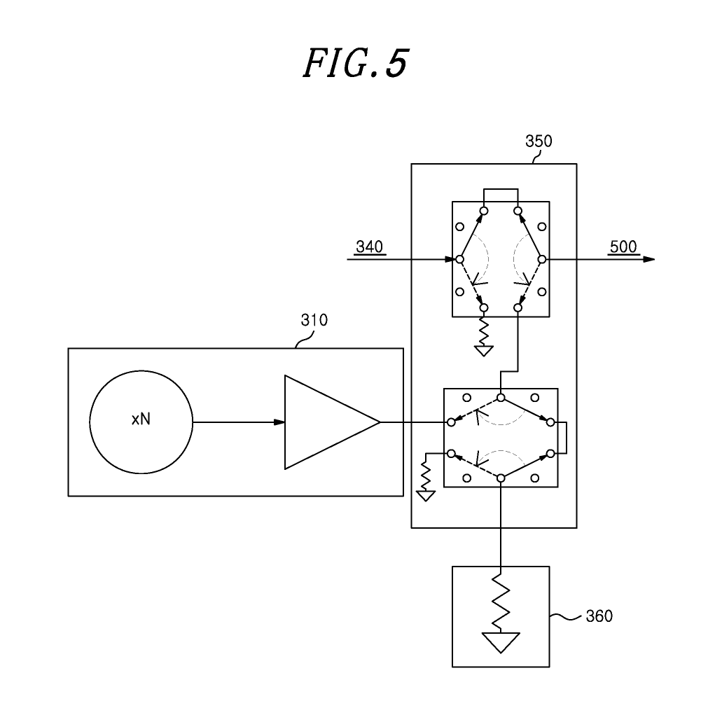

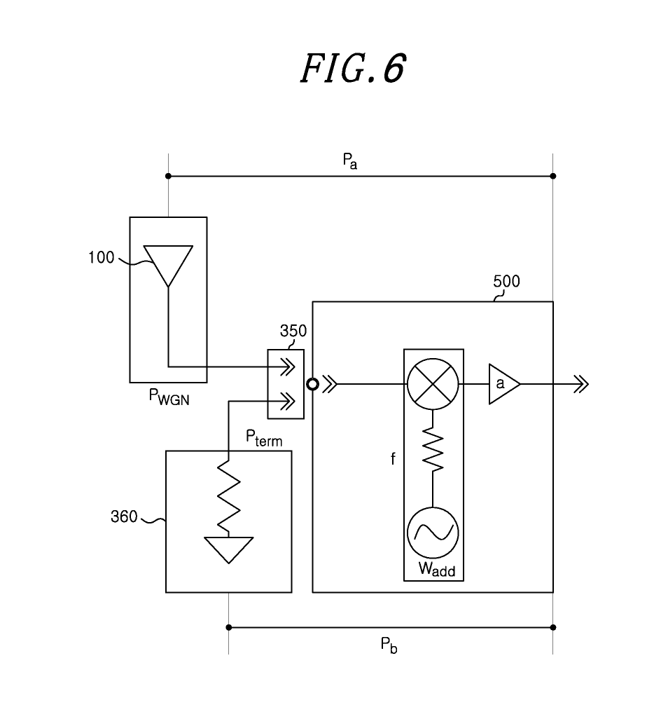

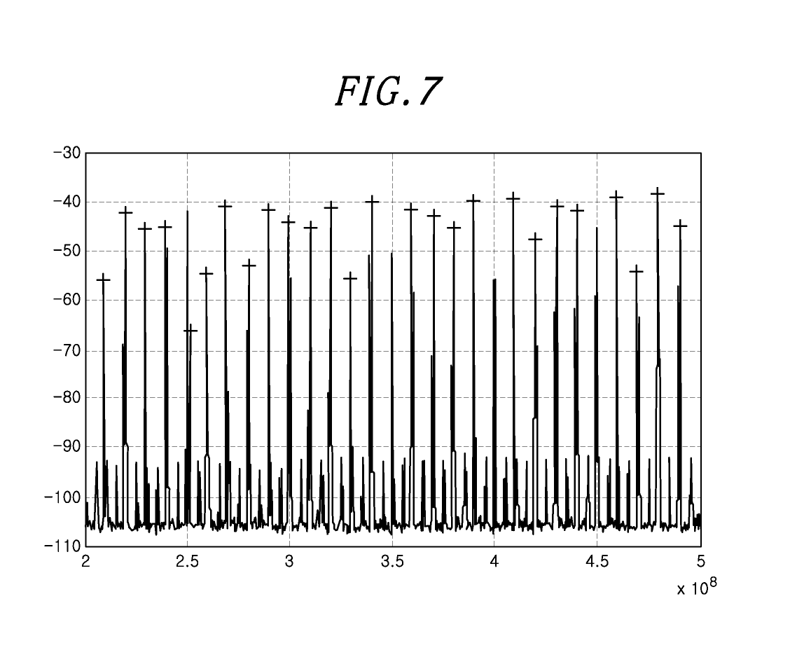

FIG. 4 is a block diagram of the comb signal generating module shown in FIG. 3; FIG. 5 depicts a circuit diagram of the comb signal generating module, the receiving path selecting module and the input termination circuit shown in FIG. 3; FIG. 6 is a conceptual circuit diagram explaining an internal noise of the radio measuring and receiving apparatus shown in FIG. 1; and FIG. 7 depicts a graph showing a frequency spectrum generated from the comb signal generating module shown in FIG. 3.

Referring to FIG. 4, the comb signal generating module 310 may include a variable reference clock generator 311, a nonlinear amplifier 313, a nonlinear transmission line 315, and an impulse forming network 317. In this connection, FIG. 7 shows a frequency spectrum of 100 MHz fundamental wave oscillated in the comb signal generating module 310. The detailed configuration of the comb signal generating module 310 is well known to those skilled in the art. Therefore, the detailed description thereof will be omitted.

Referring to FIG. 5, the hybrid interface apparatus 300 is connected to the dual mode antenna 100 and/or the radio measuring and receiving apparatus 500 by means of the receiving path selecting module 350. The connection of the hybrid interface apparatus 300 to the radio measuring and receiving apparatus 500 can be made by way of the input termination circuit 360 or the comb signal generating module 310. Furthermore, the receiving path selecting module 350 enables the connection between the dual mode antenna 100 and the radio measuring and receiving apparatus 500 in a normal state where the control signal is not supplied from the bias power controlling unit 330. However, the receiving path selecting module 350 enables the connection between the input termination circuit and the radio measuring and receiving apparatus 500 in a case where the externally received noise is blocked.

Referring to FIG. 6, a conceptual circuit diagram is shown to explain an internal noise of the radio measuring and receiving apparatus 500. As illustrated in FIG. 6, the radio measuring and receiving apparatus 500 may measure its own internal noise and the external noise generated from the dual mode antenna 100 and may receive the noise level measured by the hybrid interface apparatus 300. The noise level can be calculated as the following Equation 1.

$${p}_{wgn} = {p}_{a} - \frac{f - 1}{f} {p}_{b} \qquad [ Equation 1 ]$$

where p_{wgn} denotes a white Gaussian noise power, pₐ denotes a mean value of radio noise in a linear unit, p_{b} denotes a noise power value in a linear unit of the radio measuring and receiving apparatus 500, and f denotes a noise factor.

The RF receiver of the embodiment has the ability to transfer the bias power and the RF signal via one RF cable and enables the dual mode antenna to drive in the active antenna mode and the passive antenna mode by supplying or not supplying the bias power to the dual mode antenna.

Description of the present invention as mentioned above is intended for illustrative purposes, and it will be understood to those having ordinary skill in the art that this invention can be easily modified into other specific forms without changing the technical idea and the essential characteristics of the present invention. Accordingly, it should be understood that the embodiments described above are exemplary in all respects and not limited thereto. For example, respective components described to be one body may be implemented separately from one another, and likewise components described separately from one another may be implemented in an integrated type.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A wideband RF receiver comprising:
a dual mode antenna configured to drive in an active antenna mode when a bias power is supplied thereto and to drive in a passive antenna mode when a power is not supplied thereto;
a hybrid interface apparatus configured to supply the bias power to the dual mode antenna and configured to provide a control signal that enables the dual mode antenna to drive in the active antenna mode or the passive antenna mode; and
a radio measuring and receiving apparatus configured to measure a signal level of an input value that the hybrid interface apparatus outputs the control signal.

2. The wideband RF receiver of claim 1, wherein the dual antenna mode comprises:
an antenna path switch;
a low noise amplifier disposed on an active antenna path of the antenna path switch; and a bias-tee circuit configured to separate the RF signal and the bias power such that the RF signal and the bias power are supplied to the low noise amplifier and the antenna path switch.

3. The wideband RF receiver of claim 1, wherein the hybrid interface apparatus comprises:
a comb signal generating module configured to generate a reference signal of a specified frequency in a target frequency band to be measured by the wideband RF receiver;
a signal level detecting module configured to measure the signal level of the RF signal inputted via the dual mode antenna; a bias power controlling unit configured to control the hybrid interface apparatus such that the power is supplied to the dual mode antenna in a case where the signal level is lower than a preset signal level and the power is not supplied to the dual mode antenna in a case where the signal level is higher than a preset signal level; and
a wideband bias power controlling module configured to supply the bias power to the dual mode antenna in accordance with the control of the bias power controlling unit.

4. The wideband RF receiver of claim 3, wherein the hybrid interface apparatus further comprises:
a receiving path selecting module configured to block a signal from the exterior in order to measure an internal spurious of the radio receiving apparatus; and
an input termination circuit connected to the radio measuring and receiving apparatus by means of the receiving path selecting module,
wherein the receiving path selecting module selects a path through which the radio measuring and receiving apparatus is connected with the dual mode antenna.

5. The wideband RF receiver of claim 4, wherein the receiving path selecting module comprises at least one switch.

6. The wideband RF receiver of claim 5, wherein the dual mode antenna and the hybrid interface apparatus are connected by an RF cable, and the hybrid interface apparatus and the radio measuring and receiving apparatus are connected by an RF cable.
